(19) United States
(12) Patent Application Publication
(10) Pub. No.: US 2010/0090702 A1
(43) Pub. Date: Apr. 15, 2010

(54) IN SITU BATTERY TESTER

(75) Inventors: Keith McMillen, Berkeley, CA (US); Douglas F. Widney, San Francisco, CA (US); Dennis A. Saputelli, San Francisco, CA (US)

Correspondence Address: Weaver Austin Villeneuve & Sampson LLP, P.O. BOX 70250, OAKLAND, CA, 94612-0250, US

(73) Assignee: KESUMO LLC, Berkeley, CA (US)

(21) Appl. No.: 12/436,614

(22) Filed: May 6, 2009

Related U.S. Application Data
(60) Provisional application No. 61/104,178, filed on Oct. 9, 2008.

(51) Int. Cl. G01N 27/416

(52) U.S. Cl. 324/426

(57) ABSTRACT

A battery tester is described that can measure the life of a battery without requiring direct access to or removal of the battery from the musical instrument or effects box in which the battery is installed.

### RELATED APPLICATION DATA

The present application claims priority under 35 U.S.C. 119(e) to U.S. Provisional Patent Application No. 61/104,178 entitled BATT-O-METER filed on Oct. 9, 2008 (Attorney Docket No. KSMOP002P), the entire disclosure of which is incorporated herein by reference for all purposes.

### BACKGROUND OF THE INVENTION

The present invention relates to battery testers and, in particular, to battery testers capable of testing batteries installed in devices without having to gain direct access to the installed batteries.

Over a million battery-powered floor effects (e.g., stomp boxes) have been sold in the electronic and amplified music industry every year for the last 30 years. More and more guitars (both electric and acoustic) have battery-powered preamps. All of these products use the well known rectangular 9 volt battery.

For most of these devices, the battery is installed internally requiring the removal of numerous screws and a cover plate to test and or change the battery. In general, there is no way to know if the battery is good or bad without removing it. As a result, most musicians automatically change the battery once they have gone through the task of opening the compartment whether the battery still has useful life or not. No one wants to have a guitar or processor go dead during a rehearsal or show. Thus, millions of batteries are tossed out prematurely.

### SUMMARY OF THE INVENTION

According to the present invention, an in-situ battery tester is provided. According to a particular class of embodiments, a battery tester is provided for testing a battery under test installed in a device without requiring direct access to or removal of the battery under test. A stereo plug is configured for insertion into a stereo jack on the device to thereby complete a circuit including the battery under test and a load circuit in the device to which the battery under test supplies power. First circuitry is configured to measure a battery voltage corresponding to the battery under test. Second circuitry is configured to measure a load current corresponding to the load circuit to which the battery under test supplies power. Control circuitry is configured to generate one or more signals representative of remaining battery life for the battery under test with reference to the battery voltage and the load current. A display is configured to generate a representation of the remaining battery life using the one or more signals. According to some embodiments, the representation of the remaining battery life includes one or both of a voltage or a number of hours.

According to a specific embodiment, the battery tester includes two contacts external to its housing and in electrical communication with fourth circuitry. The two contacts and the fourth circuitry are configured for testing of a first type of loose battery connected to the contacts. According to a more specific embodiment, the fourth circuitry is further configured for testing of at least one additional type of loose battery connected to one of the contacts and a tip conductor of the stereo plug.

According to another specific embodiment, the control circuitry includes an analog-to-digital converter having an input range, and the battery tester includes ranging circuitry configured to adapt the battery voltage to the input range of the analog-to-digital converter.

According to still another specific embodiment, the second circuitry employs a sense resistance comprising a combination of one or more of a plurality of sense resistors to measure the load current, and includes selection circuitry configured to select from among the sense resistors for different ranges of a current signal generated by the sense resistance.

According to yet another specific embodiment, the battery tester includes third circuitry configured to select a battery chemistry type. The control circuitry is configured to generate the one or more signals representative of remaining battery life with reference to the selection of battery chemistry type.

According to a further specific embodiment, the stereo plug comprises a first tip conductor, a first ring conductor, and a first sleeve conductor configured to contact a second tip conductor, a second ring conductor, and a second sleeve conductor in the stereo jack, respectively. The stereo plug has a profile that makes it unlikely that the first tip conductor causes a short circuit between the second ring conductor and the second sleeve conductor as the stereo plug is being inserted into the stereo jack.

According to yet another specific embodiment, the control circuitry includes a microcontroller configured to employ a representation of the battery voltage as an index into a lookup table to select a current*time value, and to generate the one or more signals representative of remaining battery life by dividing the current*time value by a representation of the load current. According to a more specific embodiment, the battery tester includes third circuitry configured to select a battery chemistry type, and the lookup table is one of a plurality of lookup tables each of which corresponds to a particular battery chemistry type. The microcontroller is configured to select the lookup table from among the plurality of lookup tables with reference to the battery chemistry type selected.

According to another more specific embodiment, the microcontroller is configured to compensate for reduction of the remaining battery life as a function of increasing current draw. According to yet another more specific embodiment, the microcontroller is configured to compensate for the remaining battery life occurring at a lower battery voltage relative to the measured battery voltage.

According to another class of embodiments, a stereo plug is provided for insertion into a stereo jack. The stereo plug includes a tip conductor, a ring conductor, and a sleeve conductor, and has a profile such that the tip conductor is narrower than a maximum width of the widest portion of the stereo plug, and the ring conductor is also narrower than the maximum width of the stereo plug. The stereo plug includes a first dielectric insulator insulating the tip conductor from the ring conductor, and a second dielectric insulator insulating the ring conductor from the sleeve conductor. A portion of the first dielectric insulator increases in width from the tip conductor to the maximum width and then decreases in width from the maximum width to the ring conductor. A portion of the second dielectric insulator increases in width from the ring conductor to the maximum width.

A further understanding of the nature and advantages of the present invention may be realized by reference to the remaining portions of the specification and the drawings.

### BRIEF DESCRIPTION OF THE DRAWINGS

FIG. 1 is a simplified circuit diagram illustrating connection of a battery installed in a device to both mono and stereo plugs via a stereo jack.

FIG. 2 is a depiction of a battery tester according to a specific embodiment of the invention.

FIG. 3 is a block diagram and schematic of a battery tester designed in accordance with a specific embodiment of the invention.

FIGS. 4-10 are flow diagrams illustrating operation of a battery tester according to various specific embodiments of the invention.

FIG. 11 includes side and cross-sectional views of a stereo plug for use with battery testers designed in accordance with specific embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

The present invention provides a battery tester (specific embodiments of which are referred to herein as the “Batt-O-Meter”) that can measure the life of a battery without requiring direct access to or removal of the battery from the device it is powering. As will be understood with reference to the Background of the Invention, such a battery tester is particularly advantageous for testing batteries installed in musical instruments and related devices, and specific embodiments are described herein with reference to such applications. However, it should be noted and will be understood by those of skill in the art that the basic principles of the present invention are more generally applicable.

According to a particular class of embodiments, a battery tester is provided that has an associated stereo plug (e.g., a conventional ¼″ plug or a modified plug as described below) that may be inserted into the available jack on the instrument or device, e.g., a stomp box. According to specific implementations, once the jack is inserted, the tester's display reports the voltage and, in some implementations, how many hours of life the battery has left to power the device in which it is installed.

During normal operation, the instruments and devices for which some embodiments of the invention are designed sense the insertion of the ¼″ plug to apply power to the components to which the battery under test supplies power. Taking advantage of this standard configuration, the Batt-O-Meter can measure critical information that lets the user know how much longer the battery will work without having to make direct contact to the positive contact of the battery as is usually required. In addition, as will be discussed, embodiments of the Batt-O-Meter may be configured to test any stand-alone battery (9V, AAA, AA, C, D, etc.), as well as other types of cells such as, for example, prismatic or button cells. Embodiments are also contemplated that enable the testing of different battery chemistry types, e.g., alkaline, carbon-zinc, rechargeable (e.g., NiCd, LiPo, or NiMH), etc., with the same battery tester.

For the price of a handful of batteries, embodiments of the present invention provide a sophisticated, accurate, and easy to use battery tester that can save time, money, and possible embarrassment on stage.

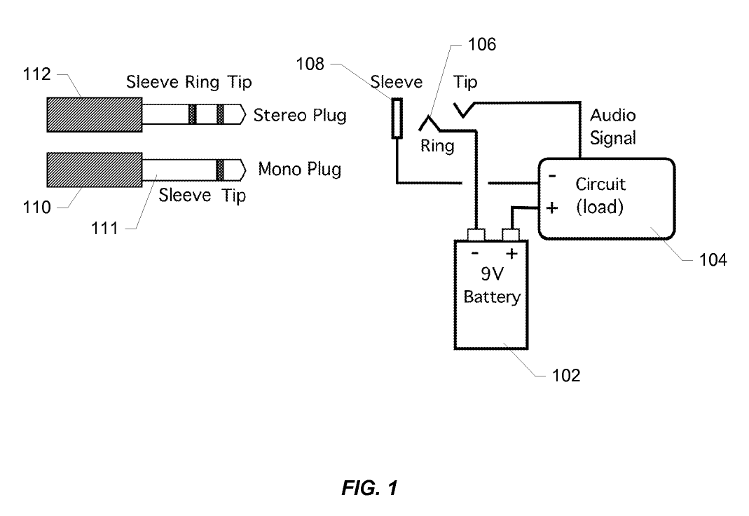

As mentioned above, musical effects devices such as stomp boxes and musical instruments typically use a standard ¼″ diameter plug and jack to connect with other equipment. These devices take advantage of the differences between mono (i.e., single conductor and ground) and stereo (i.e., two conductors and ground) plugs and jacks to easily and cheaply turn a device on merely by plugging a mono plug into a stereo jack. This may be understood with reference to FIG. 1. As shown, a 9 volt battery 102 is wired so its positive terminal is tied to the high side of the circuit (load) 104 and its negative terminal (ground) is tied to the ring 106 of a female stereo jack. The ground or return path of circuit 104 is tied to the sleeve 108 of the stereo jack. When a mono plug 110 is inserted into the female stereo jack, the ground or return path is completed by virtue of the connection established between ring 106 and sleeve 108 by mono plug conductor 111, and circuit 104 turns on.

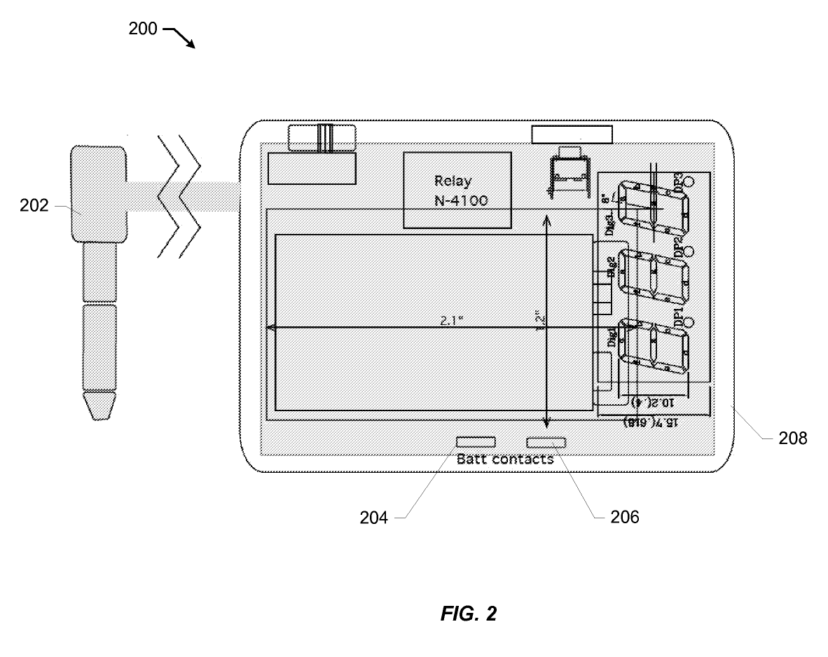

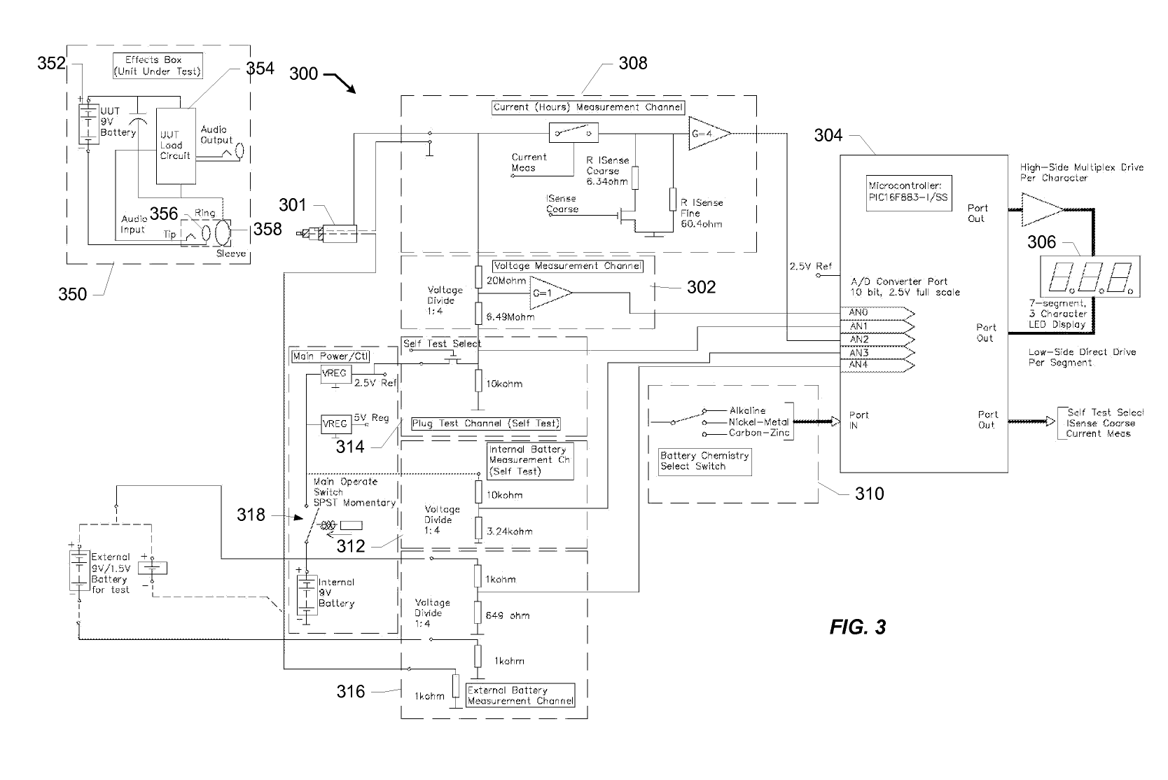

According to a particular implementation illustrated in FIGS. 2 and 3, Batt-O-Meter 200 has a stereo plug 202 (or an equivalent, e.g., plug 112 of FIG. 1) that the user inserts into the female stereo jack on the device in which the battery to be tested is installed. The two isolated ring and sleeve conductors of stereo plug 202 bring the ground of the battery under test (e.g., battery 102) and the virtual return of battery's load circuit in the unit under test, i.e., the UUT, (e.g., circuit 104) into the Batt-O-Meter.

As will be described, a particular implementation of the Batt-O-Meter uses a microcontroller-based data acquisition system that reads the battery voltage and measures the current demands of the load circuit of the battery under test. Operation of a particular implementation of the code which governs the operation of the microcontroller may be understood with reference to the discussion below. Such code may be stored in physical memory or any suitable storage medium (not shown) associated with the microcontroller, as software or firmware, as understood by those of skill in the art. However, it should be noted that the use of a microcontroller or similar device is not necessary to implement the invention. Most, if not all, of the functionality described herein may be implemented using alternative technologies without departing from the scope of the invention. For example, embodiments are contemplated which implement such functionalities using programmable or application specific logic devices, e.g., PLDs, FPGAs, ASICs, etc. Alternatively, analog circuits and components may be employed. As yet another alternative, at least some functionality may be implemented using mechanical components. These and other variations, as well as various combinations thereof, are within the knowledge of those of skill in the art, and are therefore within the scope of the present invention.

Referring now to FIG. 3, the functional blocks and components of a battery tester 300 designed according to a specific embodiment of the invention is shown. An “effects box” is also shown as an example of a unit under test (UUT) 350 into which stereo plug 301 may be inserted, although it will be understood that battery tester 300 may be used with any device having a suitable jack input. Voltage measurement block 302 includes a high impedance voltage divider (e.g., over 20 Mega ohm) configured to read the voltage of battery 352 in UUT 350, i.e., the battery under test. According to a particular embodiment, this measurement is done prior to any power being applied to load circuit 354 for accuracy. However, it should be noted that this voltage may be read at other times and under other load conditions without departing from the scope of the invention. The value of this voltage measurement is buffered and ranged before being fed into an analog-to-digital converter which is part of microcontroller 304. As will be discussed, careful ranging may result in more efficient computation by microcontroller 304 which may also simultaneously be performing other background tasks, e.g., servicing digital readout 306.

A current measurement block 308 employs one or more sense resistors applied across the ring and sleeve inputs to the Batt-O-Meter (e.g., ring 356 and sleeve 358). The drop across the sense resistor(s) is proportional to the current that load circuit 354 draws. According to a specific implementation, and as will be discussed, current measurement block 308 is auto ranging using switchable sense resistances (e.g., R ISense Coarse and R ISense Fine). Auto ranging allows for extremely accurate measurements, e.g., from a few micro amps to tens of milliamps, with microcontroller 304 determining the appropriate sense resistor(s) to utilize. Depending on the implementation, more or fewer sense resistors may be used for more or less range. According to some implementations, multiple readings may be taken to guarantee accurate data.

Once the voltage and current are known it is possible, assuming a particular battery chemistry type, to determine the remaining time (e.g., the number of hours) the battery under test will operate in the device in which it is installed. That is, this determination is dependent on the type of chemistry that the battery under test employs. Therefore, according to a specific embodiment, the user may select a particular battery chemistry type via a three-position switch 310 (e.g., a 3 position slide switch implemented as a double-pole, triple-throw (dp3t) switch) for which the different positions correspond to alkaline, carbon-zinc, or rechargeable (e.g., NiCd or NiMH) cells. Embodiments may also support other battery chemistries, including but not limited to various forms of lithium batteries. Microprocessor 304 uses the chemistry information to select a corresponding look up table that includes parameter values for determining the remaining time of operation which is then presented on display 306, in this case a 3-digit LED or LCD display. According to an alternative embodiment, the display is implemented using green, yellow, and red diodes which are selectively activated using the same or equivalent information provided to the 3-digit display to indicate “good,” “fair,” and “poor” charge levels. A variety of other mechanisms for conveying this information are also contemplated.

It should also be noted that embodiments of the invention are contemplated in which the battery chemistry is assumed to be a particular type, i.e., the battery tester is configured only for testing batteries of a particular chemistry type. Thus, mechanisms for specifying the chemistry type of the battery under test are optional.

According to some implementations, and as will be discussed, the Batt-O-Meter may include a self-test mode that checks the battery powering the tester (e.g., internal battery measurement block 312), and/or the cleanliness (e.g., conductivity) of the stereo plug (e.g., plug test block 314) and provides feedback to the user via the display.

According to some implementations, external 9 volt batteries, i.e., batteries not installed in devices, can also be tested using external battery measurement block 316 via contacts external to the Batt-O-Meter (e.g., contacts 204 and 206 of FIG. 2). Cylindrical 1.5V cells (e.g., AAA, AA, C, or D cells), and other cells such as prismatic or button cells, may also be tested by placing their positive terminals on one of these contacts and touching the tip of the Batt-O-Meter stereo plug to the negative terminal. Such external batteries are represented by battery 370 of FIG. 3. Additional details about the operation of a particular implementation in this mode are discussed below.

Referring again to FIG. 2, Batt-O-Meter 200 is built into a rugged plastic case 208 with a Mylar overlay label that contains all operating instructions. The unit may be further designed to allow storage without accidental turn on of the device, which would drain its internal battery.

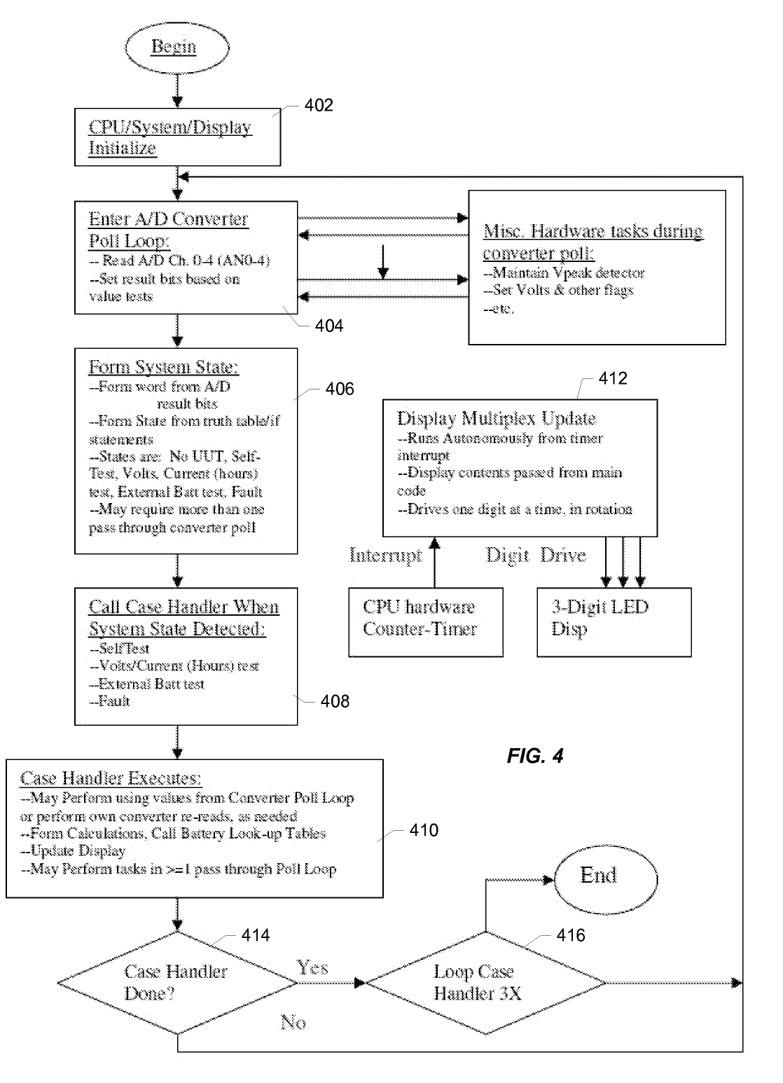

FIGS. 4-10 are flow diagrams illustrating operation of a battery tester in accordance with a specific embodiment of the invention. FIG. 4 is a top-level diagram which begins with the initialization of the various system components when the battery tester is powered up (402). After initialization, the microcontroller enters an A/D converter poll loop in which the analog input channels to the microcontroller, e.g., inputs AN0-AN4 of microcontroller 304, are polled (404). Various miscellaneous hardware tasks are performed in conjunction with this poll loop.

The results of the poll loop are used to determine the current state of system (406). For example, the system state might be that there is currently no UUT connected to the tester. Alternatively, the system might be determined to be in self-test mode, voltage measurement mode, current measurement mode, external battery test mode, fault condition, etc.

According to a specific embodiment, a single-pole, single-throw tact momentary switch (e.g., switch 318 of FIG. 3) controls the entire unit. In this embodiment (operation of which is illustrated in Table 1), activating the switch with no UUT or external battery voltage present, triggers self-test. Additionally and as described below, the presence of a UUT triggers a combined voltage/hours test, which sequences automatically from voltage to current measurement using a relay.

TABLE 1
One Button Auto Implementation

| | | UUT with Batt | External Batt |
|---|---|---|---|
| Unit Function | Power SW | Connected | Connected |
| Off | Off | Off | Don't Care |
| Self-test | On | No | No |
| UUT Batt | On | Yes | No |
| Volts/Hours of | | | |
| Operation | | | |
| Illegal | On | Yes | Yes |

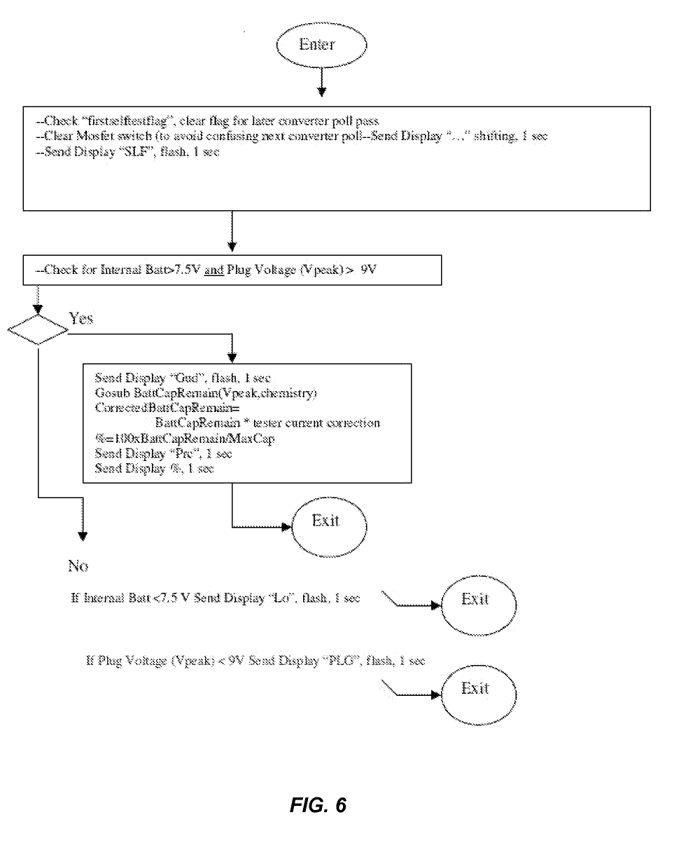

Referring again to FIG. 4, the determined system state will cause a particular case handler routine to be called (408). That is, for example, if the system is determined to be in voltage measurement mode, the voltage measurement case handler is executed. Examples of the operation of various case handlers are described in greater detail below with reference to FIGS. 6-10. Execution of the called case handler (410) may use values obtained during a previous run through the poll loop, e.g., as in 404, or may initiate one or more additional runs of the poll loop to obtain the necessary readings. In conjunction with or independent of case handler execution, the battery tester display may be updated as illustrated by 412. According to various implementations, and as a general principle, a called case handler may execute more than one pass through its loop as desirable (414). According to the implementation shown, the process ends after the case handler has executed three times (416).

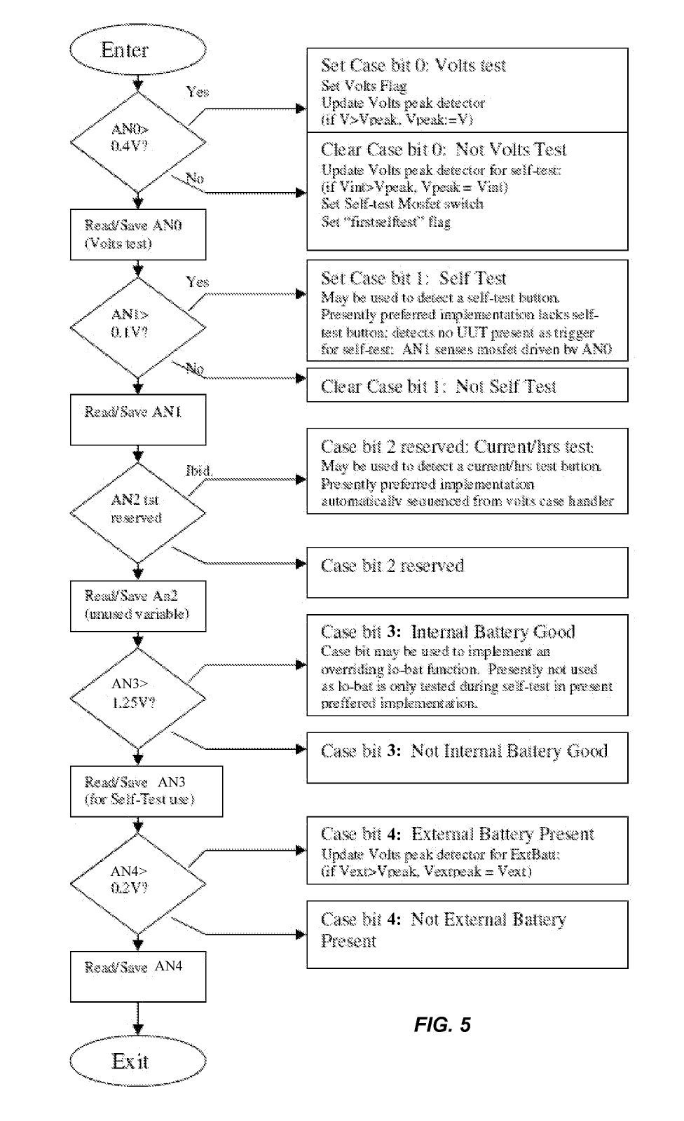

FIG. 5 illustrates a run through example of an A/D converter poll loop (e.g., 404 of FIG. 4) according to a specific embodiment of the invention. The value of each of a plurality of A/D channels ANx is read relative to some threshold value, and a corresponding case bit is set or cleared depending on the result. The value of each A/D channel is also saved. For example, if AN0 is greater than 0.4 volts, case bit 0 is set indicating that a voltage measurement test is to be performed, a Volts flag is set, and a Volts peak detector is updated. On the other hand, if AN0 is less than 0.4 volts, case bit 0 is cleared and the system prepares for self-test mode. Then if AN1 is greater than 0.1 volts, case bit 1 is set indicating self-test mode. Alternatively, self-test may be the default mode when the tester determines that there is no UUT present. FIG. 5 also illustrates that certain dedicated system tasks may be performed during the converter poll loop. For example, consider Case Bit 0. It is useful to set a flag bit for future reference indicating that an in-range voltage has been acquired.

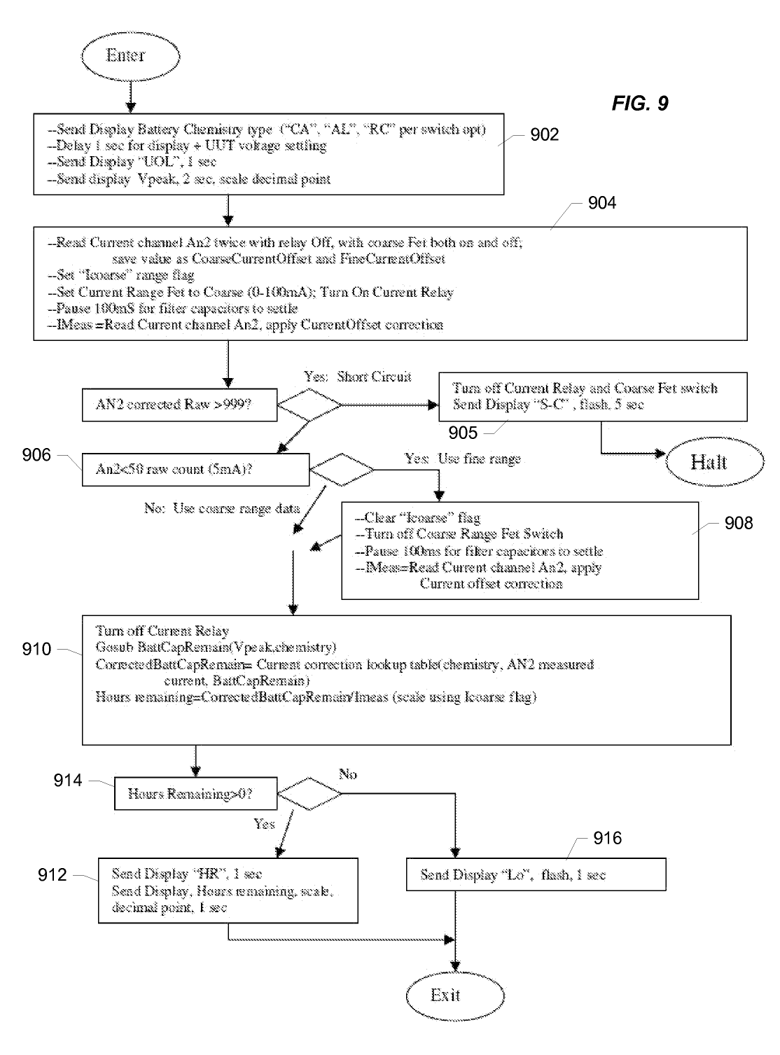

The A/D converter poll loop goes through a sequence of reads, flags, and saves for the A/D channels depending on the particular implementation. As shown in FIG. 5, some channels ANx and the corresponding case bits may be reserved to implement future functionalities, e.g., as shown, channel AN2 and case bit 2 are indicated as being reserved. Such a functionality might be, for example, a separate current/hours test. That is, according to a particular implementation, the voltage of the battery under test and the current of the battery's load circuit may be automatically measured together in a single volts/current measurement mode. However, embodiments are contemplated in which these measurements are made in distinct measurement modes. It is also worth noting that, in a particular embodiment described below, channel AN2 is used to record current measurements for the case handler that operates according to the combined volts/current measurement mode (see FIG. 9).

FIG. 5 also shows channel AN3 and case bit 3 as indicating whether the battery tester's internal battery is good, as well as channel AN4 and case bit 4 as indicating whether an external battery is present (e.g., a loose 1,5 or 9 volt battery for testing as mentioned above). As will be understood, the states detected and the sequence illustrated by the A/D converter poll loop of FIG. 5 are merely examples of states and sequences which might be employed with various embodiments of the invention.

FIG. 6 is an illustration of a self-test case handler for use with various embodiments of the invention. In this example, the battery tester indicates a successful self-test if both the internal battery has a voltage in excess of 7.5 volts, and the voltage channel AN0 measures in excess of 2.25 volts while Self-Test circuit 314 injects 2.5 volts near the bottom of the input voltage divider. The latter condition indicates that the plug is sufficiently free of shunt leakage current, e.g., clean. Additionally the self-test mode may display the charge level of the internal battery powering the device as a percentage of total usable life.

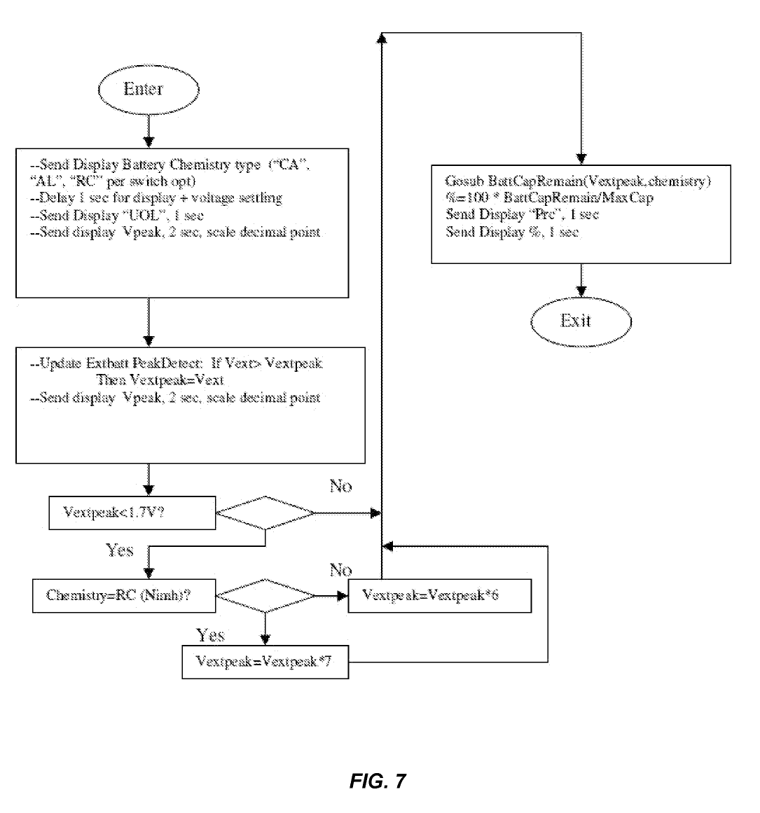

FIG. 7 is an illustration of an External Battery Test case handler for use with various embodiments of the invention. In this example, depending on the battery chemistry type, and a peak voltage measurement of an external battery, e.g., a loose battery connected to an external contact on the battery tester, the remaining battery capacity as a percentage of its maximum capacity is represented on the display.

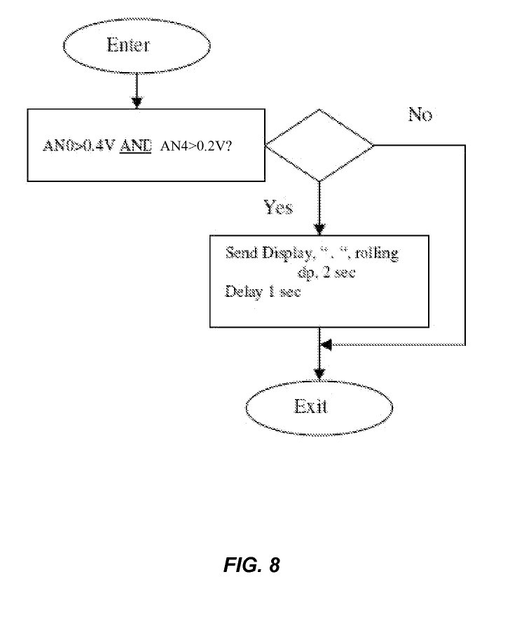

FIG. 8 is an illustration of a Fault case handler for use with various embodiments of the invention. In this example, when AN0 is greater than 0.4 volts and AN4 is greater than 0.2 volts, i.e., indicating that the battery tester is simultaneously connected to a battery in a UUT and an external battery, a fault condition is triggered.

FIG. 9 is an illustration of a combined Volts and Current-Hour Test case handler for use with various embodiments of the invention. As mentioned above, embodiments are contemplated in which separate case handlers for measuring volts and current-hours are implemented. In the embodiment depicted, the battery chemistry type is displayed followed by the voltage of the battery under test in the UUT (902). Referring to the implementation shown in FIG. 3, this information would be derived from battery chemistry select switch 310, and voltage measurement block 302 (i.e., channel AN0).

A current measurement for the UUT is then made, e.g., using current (hours) measurement block 308 of FIG. 3. According to the embodiments illustrated in FIGS. 3 and 9, coarse and fine offset currents are measured (i.e., channel AN2) with the block's relay open to get a baseline for use in later correction of the UUT current measurements, followed by a coarse measurement of the UUT current (i.e., again channel AN2) with the coarse offset correction being applied (904). The measurement is performed first using the coarse range for two reasons. Firstly, the lower value coarse current sense resistor value will charge the UUT bypass capacitors most rapidly. Secondly, an overrange voltage may be used to detect a short circuit. In that case, the current relay will be turned off, a fault displayed, and execution halted (905). If the measured current is in range but relatively high (906), e.g., greater than 5 mA, the coarse current measurement (i.e., using R ISense Coarse in parallel with R ISense Fine) is used. On the other hand, if a low current is measured (906), a fine current measurement is taken (i.e., using R ISense Fine only) (908). Using the measured voltage of the battery under test, the battery chemistry type, and either the coarse or fine current measurement, the remaining battery capacity, e.g., hours of operation remaining at that load current, is determined (910) and displayed (912). According to a particular embodiment, if the remaining capacity is below some threshold, e.g., 1 hour (914), the display presents an indication that the battery life is unacceptably low, e.g., “LO” (916).

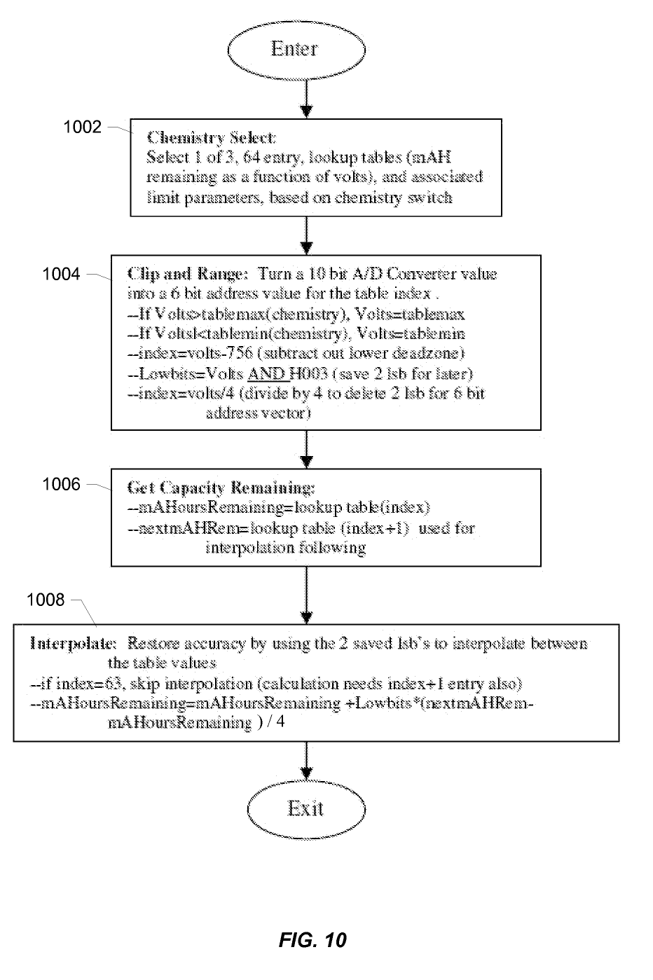

FIG. 10 is an illustration of a Battery Capacity Remaining subroutine which generates the value BatCapRemain employed by the case handlers illustrated in FIGS. 6, 7, and 9. As can be seen, based on the indicated battery chemistry type, one of three 64 entry lookup tables is selected (1002). A clipped and ranged value derived from the measured voltage is then generated for use as an index into the selected lookup table (1004), which is used to select a current*time remaining value (e.g., mA*hours) from the table (1006). According to a specific embodiment, an interpolation between adjacent table values may be performed (1008) to improve accuracy beyond the resolution of the table.

According to particular implementations, additional corrections related to current draw may be introduced. According to a particular class of embodiments, one such correction compensates for the reduction or de-rating of battery capacity as a function of increasing current draw which occurs in many battery chemistries. This may be achieved, for example, using a small (e.g., 8 entry) piecewise lookup table for each chemistry.

According to another class of embodiments, an implicit impedance correction factor may be built into the battery capacity tables to compensate for the phenomenon that the remainder of the lifecycle occurs at a lower battery voltage relative to that measured at any given moment. To the extent that the load is resistive rather than constant current, the current draw will decrease relative to the presently measured current draw. Experimentation with effects boxes from various manufacturers showed that, on average, the load curve may be modeled as 60% resistive and 40% constant current. This assumption may then be used to pre-distort the battery capacity table(s) relative to a standard constant-current load.

The final, corrected battery capacity value is then used to derive the time remaining (e.g., in hours) using the measured load current (e.g., see 910 of FIG. 9).

As a consequence of the impedance correction factor built into the battery capacity table in some embodiments, a reverse correction factor may need to be applied when the tables are used to calculate percent remaining for an external battery (e.g., 370 of FIG. 3) or for the Batt-O-Meter internal battery (e.g., 352 of FIG. 3). As these applications may be deemed less critical in some implementations than the UUT hours test, alternative methods, e.g., a simple slope-intercept approximation formula, may be employed for the back-correction. In other embodiments of the invention, such corrections might be applied in other ways such as, for example, by having the main battery capacity table be uncorrected, and locally applying correction factors to the UUT hours test instead. Other alternatives are within the capabilities those of skill in the art.

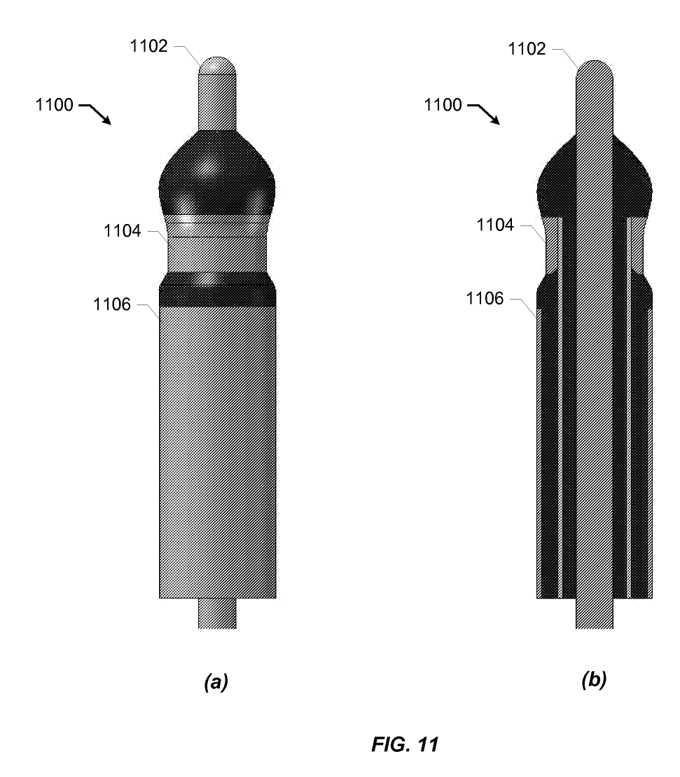

During testing of Batt-O-Meter designs, it was found that the configuration of some devices in which the battery under test was installed was such that a standard stereo plug (e.g., plug 112 of FIG. 1) sometimes resulted in an electrical connection being made between the sleeve and the ring, or between either of these and the tip, resulting in a normal or partial operation condition of the load circuit, e.g., the load circuit turned on as if a mono plug had been inserted. Such conditions may involve charging of coupling capacitors and/or load circuit bypass capacitors which could interfere with the subsequent voltage measurement. Therefore, according to a specific embodiment of the invention, a modified stereo plug was developed to decrease the likelihood of this occurring. An example of such a modified stereo plug is shown in FIG. 11 in both side and cross-sectional views; (a) and (b), respectively.

Like conventional stereo plugs, modified stereo plug 1100 has three conductors, i.e., signal conductors 1102 and 1104, and ground conductor 1106. However, in contrast with conventional stereo plugs (e.g., stereo plug 112 of FIG. 1), modified stereo plug 1100 has a profile which decreases the likelihood that tip conductor 1102 simultaneously makes contact with the ring and sleeve conductors in the UUT as the plug is being inserted. The relatively narrower diameter of tip conductor 1102 in conjunction with the tapering of the plug to the full width of a standard plug makes this possible. The profile narrows at ring conductor 1104, and then widens again to the conventional plug width before ground conductor 1106.

The narrowing at ring conductor 1104 prevents bridging to the sleeve contact on the jack during insertion. According to a specific implementation, tip conductor 1102 is a straight 0.080 pin designed to avoid contact with the sleeve or the ring on the jack during insertion. The tapered dielectric at the base of the 0.080 pin prevents the plug from hanging up on certain jacks during insertion. The similar tapers at either edge of the recessed ring conductor 1104 serve a similar purpose.

Other embodiments, included within the scope of the invention, may employ software, electronic, or mechanical mechanisms to counteract the accidental or deliberate (via the current test) charging of UUT bypass or coupling capacitors. These mechanisms may include but are not limited to: fixed voltage settling delay, variable or conditional voltage settling delay, settling time or value prediction such as a Taylor series or other algorithm, or electronic circuitry for discharging or for charge injection.

According to a specific embodiment, and as mentioned above, tip conductor 1102 may be employed to facilitate testing of loose, external batteries, e.g., using external battery measurement block 316 of FIG. 3. As shown in FIG. 3, the tip conductor of plug 301 is connected to block 316 as an alternative to, or in addition to one of the two contacts on the outside of the Batt-O-Meter housing (e.g., contacts 204 and 206 of FIG. 2). In such embodiments, the narrow end of tip conductor 1102 is advantageous in that it is easily secured against the contact of a loose battery, e.g., the depression associated with the anode of a typical cylindrical battery cell.

In a specific embodiment, the tip is connected to the negative terminal of the external battery (e.g., battery 370 of FIG. 3). However, neither the tip nor the negative terminal of the contact pair outside the Batt-O-Meter housing is connected to ground. Instead, in order to prevent shorting if a battery is connected to the incorrect terminal, an individual series resistor may be connected to each of the tip and the negative housing terminal as shown in block 316 of FIG. 3. These resistors may also form part of the measurement resistive voltage divider, creating a pseudo-ground.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A battery tester for testing a battery under test installed in a device without requiring direct access to or removal of the battery under test, comprising:
a stereo plug configured for insertion into a stereo jack on the device to thereby complete a circuit including the battery under test and a load circuit in the device to which the battery under test supplies power;
first circuitry configured to measure a battery voltage corresponding to the battery under test;
second circuitry configured to measure a load current corresponding to the load circuit to which the battery under test supplies power;
control circuitry configured to generate one or more signals representative of remaining battery life for the battery under test with reference to the battery voltage and the load current; and
a display configured to generate a representation of the remaining battery life using the one or more signals.

2. The battery tester of claim 1 wherein the display comprises a digital display having a plurality of characters.

3. The battery tester of claim 2 wherein the representation of the remaining battery life comprises one or both of a voltage or a number of hours.

4. The battery tester of claim 1 wherein the display comprises a plurality of light emitting diodes, and wherein the representation of the remaining battery life comprises one or more colors generated by the light emitting diodes.

5. The battery tester of claim 1 further comprising a housing containing the first circuitry, the second circuitry, and the control circuitry, and on which the display is mounted, the battery tester further comprising two contacts external to the housing and in electrical communication with fourth circuitry, the two contacts and the fourth circuitry being configured for testing of a first type of loose battery connected to the contacts.

6. The battery tester of claim 5 wherein the fourth circuitry is further configured for testing of at least one additional type of loose battery connected to one of the contacts and a tip conductor of the stereo plug.

7. The battery tester of claim 1 wherein the first circuitry comprises a high impedance voltage divider, and wherein the control circuitry includes an analog-to-digital converter having an input range, the battery tester further comprising ranging circuitry configured to adapt the battery voltage to the input range of the analog-to-digital converter.

8. The battery tester of claim 1 wherein the second circuitry employs a sense resistance comprising a combination of one or more of a plurality of sense resistors to measure the load current, and wherein the second circuitry further comprises selection circuitry configured to select from among the sense resistors for different ranges of a current signal generated by the sense resistance.

9. The battery tester of claim 1 further comprising third circuitry configured to select a battery chemistry type, wherein the control circuitry is further configured to generate the one or more signals representative of remaining battery life with reference to the battery chemistry type selected.

10. The battery tester of claim 9 wherein the third circuitry comprises switching circuitry configured to select from among a plurality of battery chemistry types, the plurality of battery chemistry types comprising two or more of alkaline, carbon-zinc, or rechargeable.

11. The battery tester of claim 1 wherein the stereo plug comprises a first tip conductor, a first ring conductor, and a first sleeve conductor configured to contact a second tip conductor, a second ring conductor, and a second sleeve conductor in the stereo jack, respectively, wherein the stereo plug has a profile that makes it unlikely that short circuits will occur between respective ones of the second tip conductor, the second ring conductor, and the second sleeve conductor as the stereo plug is being inserted into the stereo jack.

12. The battery tester of claim 1 further comprising internal battery test circuitry configured to measure a second voltage associated with an internal battery for powering the battery tester.

13. The battery tester of claim 1 further comprising plug test circuitry configured to measure a second voltage representative of conductivity of the stereo plug.

14. The battery tester of claim 1 wherein the control circuitry comprises a microcontroller programmed to control operation of the first and second circuitry and the display.

15. The battery tester of claim 14 wherein the microcontroller employs a representation of the battery voltage as an index into a lookup table to select a current*time value, and generates the one or more signals representative of remaining battery life by dividing the current*time value by a representation of the load current.

16. The battery tester of claim 15 further comprising third circuitry configured to select a battery chemistry type, wherein the lookup table is one of a plurality of lookup tables each of which corresponds to a particular battery chemistry type, the microcontroller being further configured to select the lookup table from among the plurality of lookup tables with reference to the battery chemistry type selected.

17. The battery tester of claim 15 wherein the microcontroller is further configured to compensate for reduction of the remaining battery life as a function of increasing current draw.

18. The battery tester of claim 15 wherein the microcontroller is further configured to compensate for the remaining battery life occurring at a lower battery voltage relative to the measured battery voltage.

19. A stereo plug for insertion into a stereo jack, comprising a tip conductor, a ring conductor, and a sleeve conductor, wherein the stereo plug has a profile such that the tip conductor is narrower than a maximum width of the widest portion of the stereo plug, and wherein the ring conductor is also narrower than the maximum width of the stereo plug, and wherein the stereo plug further comprises a first dielectric insulator insulating the tip conductor from the ring conductor, and a second dielectric insulator insulating the ring conductor from the sleeve conductor, a portion of the first dielectric insulator increasing in width from the tip conductor to the maximum width and then decreasing in width from the maximum width to the ring conductor, a portion of the second dielectric insulator increasing in width from the ring conductor to the maximum width.
